(19) United States
(12) Patent Application Publication
(10) Pub. No.: US 2003/0097663 A1
(43) Pub. Date: May 22, 2003

(54) Method and apparatus for dynamic provisioning of IP-based services in a DVB network

(76) Inventor: Matti Puputti, Turku (FI)

Correspondence Address: MORGAN & FINNEGAN, L.L.P., 345 Park Avenue, New York, NY, 10154-0053, US

(21) Appl. No.: 09/989,301

(22) Filed: Nov. 19, 2001

(51) Int. Cl. H04N 7/173; H04N 7/16; H04N 7/12; H04N 11/02; H04N 11/04; H04N 7/00; H04N 11/00

(52) U.S. Cl. 725/132; 725/135; 725/140; 725/152; 348/388.1; 348/461; 725/109; 725/126

(57) ABSTRACT

A digital video broadcasting network allows a group of end user terminals to dynamically select and receive broadcast content by transmitting program identifiers for a plurality of broadcasting content providers through program specific information (PSI/SI) layer signalling over multiple transport streams.

### FIELD OF THE INVENTION

The present invention relates to broadcasting digital video and audio data that are multiplexed after compression coding, and more particularly to broadcasting such data dynamically over a plurality of transport streams.

### BACKGROUND OF THE INVENTION

Digital video broadcasting (DVB) networks allow for the digital transmission of services, such as Internet Protocol (IP)-based services, television programming, multimedia content, text and audio information, to a plurality of end users over a wired or wireless network. DVB networks typically can provide access to a plurality of IP service providers over a single transport stream, and may increase the number of available IP service providers by providing additional transport streams.

In current DVB networks, configuration information such as addressing information for IP based services and DVB parameters for properly accessing such content, remain largely static on the end user terminals. Interactive information exchange between the end user terminals and the DVB network is typically required in order to change these DVB parameters and addressing information. However, such interactive exchange utilizes available bandwidth on the DVB network, since interactive information must be transmitted on a channel designated for such interaction.

Available bandwidth acts as a limitation on the amount of IP-based services that may be provided on a DVB network. Accordingly, it would be desirable to maximize bandwidth availability in order to maximize available IP-based services. Dynamic provisioning of IP-based services, whereby DVB parameters and addressing information could be readily changed to maximize bandwidth, would allow DVB networks to efficiently allocate IP-based services on one or more transport streams. However, achievable efficiency is presently limited because of the need to accommodate such interactive information with end user terminals.

Accordingly, there is a need for a method and apparatus for dynamic provisioning of IP-based services in a DVB network that addresses certain problems of existing technologies.

### SUMMARY OF THE INVENTION

The present application is directed to particular methods for accomplishing dynamic provisioning in a DVB network, and various apparatus for accomplishing such methods, whereby IP-based services may be moved dynamically within one and between many transport streams.

In particular, one aspect of the invention includes a method and apparatus for dynamically providing one or more services over a network, such as a digital video broadcasting network, using any of a computer network and a wireless network. A service having a control channel, such as an Internet Protocol control channel, is transmitted over a first transport stream to one or more end user terminals in accordance with a first configuration parameter of the service, as maintained by the end user terminals. The service may be any of a television program, multimedia content, text information, audio information and Internet Protocol (IP)-based services.

The first configuration parameter identifies the control channel with the first transport stream. The network then generates and/or transmits a second configuration parameter to the end user without receiving interactive information from the end user terminal. The second configuration parameter may include addressing and interface information and a program identifier that identifies the control channel with either a second transport stream or a second portion of the first transport stream. The network then may transmit the service to the end user terminals over the second transport stream. The second transport stream may be selected based on a data size of the service and an available bandwidth of the first and second transport streams.

In further embodiments of the present invention, a method and apparatus is provided for communicating addressing and interface information for a service to an end user terminal over a network, without interaction from the end user terminal. In accordance therewith, a service having a control channel is assigned to a first transport stream. At least one configuration parameter is then generated that includes addressing and interface information for the service. The at least one configuration parameter is communicated to an end user terminal and the service with the control channel is provided over the first transport stream. The end user terminal accesses the service by reading the at least one configuration parameter, generating an appropriate interface using the at least one configuration parameter and receiving the control channel without providing interactive information over the network.

### BRIEF DESCRIPTION OF THE DRAWINGS

Further aspects of the instant invention will be more readily appreciated upon review of the detailed description of the preferred embodiments included below when taken in conjunction with the accompanying drawings, of which:

FIG. 1 is a schematic block diagram of an exemplary DVB network;

FIG. 2 is an illustration of an exemplary network table structure that may be used for dynamic provisioning in the DVB network of FIG. 1; and

FIG. 3 is a flowchart of an exemplary process for generating and transmitting the network table of FIG. 2.

### DETAILED DESCRIPTION OF THE INVENTION

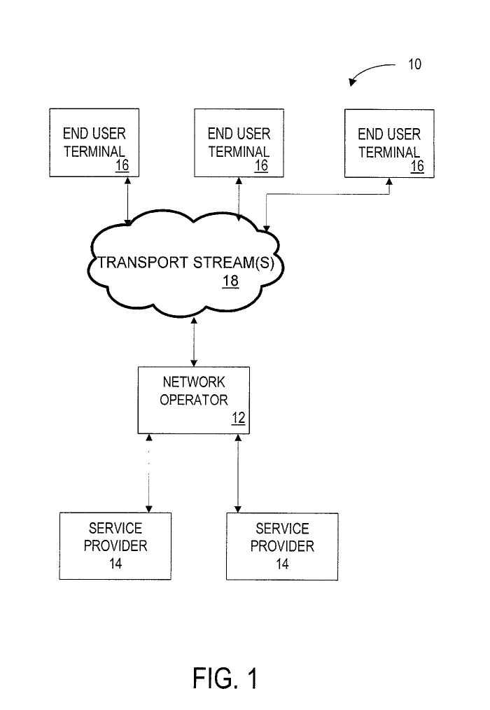

Referring now to FIGS. 1-3, wherein similar components of the present invention are referenced in like manner, preferred embodiments of a method and apparatus for dynamic provisioning of IP-based services in, for example, a DVB network are disclosed.

FIG. 1 is a diagram of an exemplary digital video broadcasting network 10. In the network 10, a network operator 12 consolidates IP-based services from the DVB content environment, such a plurality of service providers 14 (i.e., Internet Service Providers (ISPs)), and provides such services to one or more end user terminals 16 via an appropriate transport stream 18.

The network 10 may be a digital video broadcasting network operating on a computer network, such as the Internet, or a wireless network, such as a satellite or cellular network. In the case of a computer network, data may be transmitted over the transport stream 18 by a computer server operating on a local-area network, a wide-area network, the word wide web, or the like. In the case of a wireless network, transmission may be accomplished over a transport stream 18 by a high-frequency transmitter or transmitter/receiver.

The network 10 may provide services including any combination of television programming, advertising, video, audio, multimedia and text information from any number of service providers 14. In such networks as mentioned above, the number of services that may be provided are limited by the bandwidth available for the network 10. It should be readily understood that each service provider 14 may provide more than one service.

As is known in the art, in order to reduce the bandwidth required for transmitting a large amount of services, service content data may be compressed and encoded by high efficiency coding that removes redundancy, such as Motion Pictures Expert Group (MPEG) standards. Such standards compress, video data, for example, using discrete cosine transformation (DCT) and motion compensation prediction coding. With high compression ratio of IP-based service data, a plurality of such services may readily be multiplexed and transmitted over a single transmission channel or transport stream 18. The multiplexing may be performed in accordance with Multi Protocol Encapsulation (MPE) standards, such asEurpoean broadcast standard EN 301 192 published by the European Broadcasting Union.

The end user terminal 16 is any device capable of selecting data from the one or more of the transport streams 18 transmitted by the network 10. The end user terminal 16 may be a personal computer, cellular telephone, cable television set-top box, and the like. Such devices typically contain a demodulator for demodulating the bitstream data received over the transport stream 18. Such devices typically perform an error correction process of the demodulated data by using redundancy checks, and then supplies the demodulated data to a demultiplexer.

The end user terminal 16 may contain video and audio decoders to decode data in cooperation with a video decode buffer and an audio decode buffer. Because the bit stream data from the transport stream was multiplexed, data transmission speed on the transport stream is different from the bit rate used when content was encoded. The difference necessitates the inclusion of such decode buffers to convert the bit rates in accordance with the capacities of the end user terminal 16. Multiplexing according to the MPEG standards prescribe a buffer having a capacity of 512 bytes.

The demultiplexer supplies data to a processor of the end user terminal 16. The processor selects a particular service based on user instructions, retrieves appropriate packets of data corresponding to the service from the demultiplexed data, assembles the content according to previously-stored configuration information, stores the demultiplexed data in a memory (i.e. a buffer, random access memory, or other memory) and presents the content to an end user on a display or through speakers, as appropriate. In response to an instruction for retrieval of a service, the processor selects a program identifier (PID) corresponding to the service from a stored network information terminal and accesses the control channel for the service from the appropriate transport stream.

The end user terminals 16 may further contain transmitters for communicating information back to the network operator 12 over an interaction portion of the transport streams 18.

According to the present invention, the configuration information stored by the end user terminal 16 may be dynamically changed by the network operator 12 transmitting a subsequent PID indicating the location of a control channel of a particular service. The PID may contain network address information, as well as an indication of the transport stream or portion of a transport stream where the service may be received. Thus, services may be dynamically moved among the transport streams 18 or portions of a transport stream 18, and such changes readily communicated to the end user terminals 12.

Furthermore, according to the present invention the control channel may, in turn, contain interface information, such as DVB parameters that the end user terminal 16 may use to properly access and present the service to a user. Accordingly, new services may be provided or existing services may be reconfigured without the end user terminal 16 having to interactively request new configuration information over the network 10, thus preserving communication bandwidth.

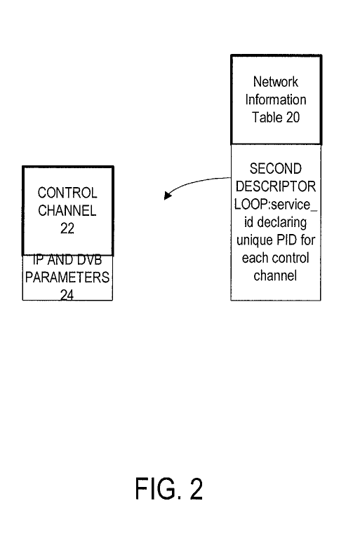

Turning now to FIG. 2, a transport stream (TS) packet is used for accomplishing multiplexing of data for transmission over the transport streams 18. As is known in the art, TS packets formed in accordance with MPEG standards have a fixed data size, such as 188 bytes. Further according to these standards, these 188 bytes include a 4-byte header and a 184-byte payload.

The 4-byte header typically includes a sync byte, an error flag, a unit start flag, a scramble control flag, a priority flag, a set of program identifier (PID) data, an adaptation field control flag, and a cyclic counter. The functions of each of these fields is well known to one of ordinary skill in the art.

In certain embodiments, the payload corresponding to the PID may have content such as IP-based service content, video and/or audio encoded data. Accordingly, the payload may contain, for example, one picture of video data or one frame of audio data. According to the invention, each payload may also contain or alternatively contain a PID identifying a control channel 20 for a particular service provided by the service providers 14.

Referring to FIG. 2, a network information table 20 is transmitted to the end user terminal 16 to correlate PIDs to particular services. Each PID, in turn, corresponds to a control channel 22, such as an Internet Protocol control channel, that can be transmitted using the PSI/SI layer of the transport stream 18 along with the network information table 20. The control channel 22 is used for relaying configuration information 24, such as network address information, and interface information, such as DVB parameters, required for properly accessing the service. The control channel 20 is transmitted over a program specific information (PSI) or PSI/SI transport layer of the transport streams 18. According to the present invention, the control channel 22 is transmitted over the transport streams 18 in such manner that previously-required interaction from the end user terminals 16 to request configuration information 18 is no longer necessary.

In further embodiments of the invention, the TS packet may include other optional fields (not shown) such as a program clock reference (PCR) field to accomplish clock synchronization between the transmitter and end user terminals 16, using, for example, a 27 MHz reference clock in a phase locked loop. The TS packet may further optionally include program time stamp information (PTS) for describing a packet length and a system time when the payload data is to be presented.

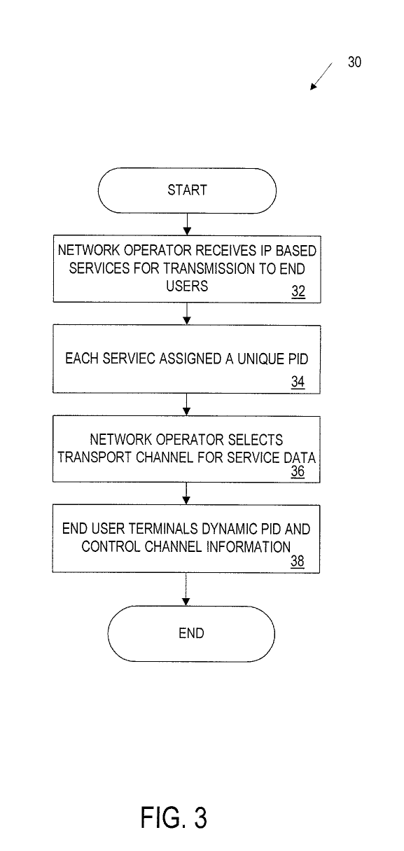

Referring now to FIG. 3, an exemplary process 30 for dynamically generating and transmitting a network table according to FIG. 2 is described. The process 30 begins when the network operator 12 receives IP-based services having a control channel from one or more service providers 14 (step 32). The IP-based services may be available from different IP networks, each controlled by their respective service providers.

Next, the service is then assigned a unique PID (step 34). Since each PID is unique, many separate services may be provided on a single network address on network 10. The control channel may be generated by the network operator 12 or the service provider 14.

The network operator 12 then selects one or more transport streams on which to transmit the control channel 22 (step 36) and DVB content via the network 10. The selection may be done based on a data size of the service or the available bandwidth on the one or more transport streams 18. The control channel 22 may be multiplexed on the selected transport stream 18 and may contain DVB parameters corresponding to interface information for the IP-based services. The control channel 22 may further contain all necessary parameters for all available services on the network 10, wherein a unique PID is assigned for each service provider 14 or available service. Thus, since each control channel 22 has a unique PID, the same network address can be used for more than one service provider 14.

The end user terminals 16 receive any changes to the PIDs of the network information table 20 and thus may identify the portion of the transport stream or streams 18 in which a particular control channel 20 is located (step 38). To accomplish this, the end user terminals 16 may create a filter for filtering the PSI/SI transport layer data to extract changes in PID information and store them for later use in accessing a service. The end user terminals 16 may use the interface information provided by the control channel 22 for a service to create a separate interface for each available service. The process 30 then ends.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

What is claimed is:

1. A method for providing dynamic provisioning of services in a network, comprising:
transmitting a service having a control channel over a first transport stream, in accordance with a first configuration parameter of the service stored by an end user terminal, in which the control channel is identified with the first transport stream;
transmitting a second configuration parameter to the end user without receiving interactive information from the end user terminal, the second configuration parameter identifying the control channel with a second transport stream; and
transmitting the service to the end user terminal over the second transport stream.

2. The method of claim 1, wherein the network is a digital video broadcasting network.

3. The method of claim 1, wherein the network is at least one of a computer network and a wireless network.

4. The method of claim 1, wherein the control channel is an Internet Protocol control channel.

5. The method of claim 1, wherein the second configuration parameter comprises data allowing the end user terminal to access the service.

6. The method of claim 1, wherein the service comprises at least one of: a television program, multimedia content, text information and audio information.

7. The method of claim 1, wherein the service is an Internet Protocol-based service.

8. The method of claim 1, wherein said transmitting the second configuration parameter further comprises:
generating the second configuration.

9. The method of claim 1, further comprising:
selecting the second transport stream based on at least one of: a data size of the service and an available bandwidth of the first and second transport streams.

10. The method of claim 1, wherein the second configuration parameter includes a program identifier for the service transmitted in the second transport stream.

11. The method of claim 1, wherein the service comprises a plurality of services from a plurality of service providers.

12. The method of claim 1, wherein the first configuration parameter comprises at least one parameter corresponding to addressing information for the service.

13. The method of claim 1, wherein the second first configuration parameter comprises at least one parameter corresponding to addressing for the service.

14. An apparatus for providing dynamic provisioning of services in a network, comprising:
means for transmitting a service having a control channel over a first transport stream, in accordance with a first configuration parameter of the service stored by an end user terminal in which the control channel is identified with the first transport stream;
means for transmitting a second configuration parameter to the end user without receiving interactive information from the end user terminal, the second configuration parameter identifying the control channel with a second transport stream; and
means for transmitting the service to the end user terminal over the second transport stream.

15. A method for providing dynamic provisioning of services in a network, comprising:
a transmitter for transmitting a service having a control channel over a first transport stream, in accordance with a first configuration parameter of the service stored by an end user terminal in which the control channel is identified with the first transport stream;
a processor for generating and transmitting a second configuration parameter to the end user without receiving interactive information from the end user terminal, the second configuration parameter identifying the control channel with a second transport stream, wherein the transmitter further for transmitting the service to the end user terminal over the second transport stream.

16. A method for dynamically receiving services in a network, performed by an end user terminal, the method comprising:
receiving a service having a control channel over a first transport stream, in accordance with a first configuration parameter of the service stored by the end user terminal in which the control channel is identified with the first transport stream;
receiving a second configuration parameter through the control channel without providing interactive information, the second configuration parameter identifying the control channel with a second transport stream; and
accessing the service over the second transport stream.

17. A method for providing dynamic provisioning of services in a network, comprising:
transmitting a service having a control channel over a first portion of a transport stream, in accordance with a first configuration parameter of the service stored by an end user terminal in which the control channel is identified with the first portion of the transport stream;
transmitting a second configuration parameter to the end user using without receiving interactive information from the end user terminal, the second configuration parameter identifying the control channel with a second portion of the transport stream; and
transmitting the service to the end user terminal over the second portion of the transport stream.

18. The method of claim 17, wherein the network is a digital video broadcasting network.

19. The method of claim 17, wherein the network is at least one of: a computer network and a wireless network.

20. The method of claim 17, wherein the control channel is an Internet Protocol control channel.

21. The method of claim 17, wherein the second configuration parameter comprises data allowing the end user terminal to access the service.

22. The method of claim 17, wherein the service comprises at least one of a television program, multimedia content, text information and audio information.

23. The method of claim 17, wherein the service is an Internet Protocol-based service.

24. The method of claim 17, wherein said transmitting the second configuration parameter further comprises:
generating the second configuration parameter.

25. The method of claim 17, further comprising:
selecting the second portion of the transport stream based on at least one of: a data size of the service and an available bandwidth of the transport stream.

26. The method of claim 17, wherein the second configuration parameter includes a program identifier the service transmitted in the second portion of the transport stream.

27. The method of claim 17, wherein the service comprises a plurality of services from a plurality of service providers.

28. The method of claim 17, wherein the first configuration parameter comprises at least one parameter corresponding to addressing information for the service.

29. The method of claim 17, wherein the second first configuration parameter comprises at least one parameter corresponding to addressing information for the service.

30. An apparatus for providing dynamic provisioning of services in a network, comprising:
means for transmitting a service having a control channel over a first portion of a transport stream, in accordance with a first configuration parameter of the service stored by an end user terminal in which the control channel is identified with the first portion of the transport stream;
means for transmitting a second configuration parameter to the end user without receiving interactive information from the end user terminal, the second configuration parameter identifying the control channel with a second portion of the transport stream; and
means for transmitting the service to the end user terminal over the second portion of the transport stream.

31. An apparatus for providing dynamic provisioning of services in a network, comprising:
a transmitter for transmitting a service having a control channel over a first portion of a transport stream, in accordance with a first configuration parameter of the service stored by an end user terminal in which the control channel is identified with the first portion of the transport stream;
a processor in communication with the transmitter for generating a second configuration parameter to the end user without receiving interactive information from the end user terminal, the second configuration parameter identifying the control channel with a second portion of the transport stream, wherein the transmitter further for transmitting the service to the end user terminal over the second portion of the transport stream.

32. A method for dynamically receiving services in a network, performed by an end user terminal, the method comprising:
receiving a service having a control channel over a first portion of a transport stream, in accordance with a first configuration parameter of the service stored by the end user terminal in which the control channel is identified with the first portion of the transport stream;
receiving a second configuration parameter through the control channel without providing interactive information, the second configuration parameter identifying the control channel with a second portion of the transport stream; and
accessing the service over the second portion of the transport stream.

33. A method for communicating a new service to an end user terminal over a network without interaction from the end user terminal, the method comprising:
assigning a service having a control channel to a first transport stream;
generating at least one configuration parameter including the control channel for the service;
transmitting the at least one configuration parameter to an end user terminal; and
transmitting the service including the control channel over the first transport stream, whereby the end user terminal accesses the service by reading the at least one configuration parameter and generates an appropriate interface using the control channel without providing interactive information.

34. The method of claim 33, wherein the network is a digital video broadcasting network.

35. The method of claim 33, wherein the network is at least one of: a computer network and a wireless network.

36. The method of claim 33, wherein the control channel is an Internet Protocol control channel.

37. The method of claim 33, wherein the second configuration parameter comprises data allowing the end user terminal to access the service.

38. The method of claim 33, wherein the service comprises at least one of: a television program, multimedia content, text information and audio information.

39. The method of claim 33, wherein the service is an Internet Protocol-based service.

40. The method of claim 33, further comprising:
selecting the transport stream based on at least one of: a data size of the service and an available bandwidth of the transport stream.

41. The method of claim 33, wherein said transmitting the configuration parameter comprises
transmitting a program identifier for the service through the transport stream.

42. The method of claim 33, wherein the service comprises a plurality of services from a plurality of service providers.

43. An apparatus for communicating a new service to an end user terminal over a network without interaction from the end user terminal, the method comprising:
means for assigning a service having a control channel to a first transport stream;
means for generating at least one configuration parameter including the control channel for the service;
means for transmitting the at least one configuration parameter to an end user terminal; and
means for transmitting the service including the control channel over the first transport stream, whereby the end user terminal accesses the service by reading the at least one configuration parameter and generates an appropriate interface using the control channel without providing interactive information.

44. An apparatus for communicating a new service to an end user terminal over a network without interaction from the end user terminal, the method comprising:
a processor for assigning a service having a control channel to a first transport stream and generating at least one configuration parameter including the control channel for the service; and
a transmitter for transmitting the at least one configuration parameter to an end user terminal and further for transmitting the service including the control channel over the first transport stream, whereby the end user terminal accesses the service by reading the at least one configuration parameter and generates an appropriate interface using the control channel without providing interactive information.

45. A method for dynamically receiving a new service over a network, performed by an end user terminal, the method comprising:
receiving at least one program identifier corresponding to a service on a network; and
selecting a control channel from the network corresponding to the packet identifier;
receiving configuration information for the service from the control channel;
generating an appropriate interface using the at least one configuration parameter; and
receiving the service without providing interactive information to a network operator.
